(19) United States
(12) Patent Application Publication
(10) Pub. No.: US 2003/0048473 A1
(43) Pub. Date: Mar. 13, 2003

(54) Printing device having a built-in device driver

(76) Inventor: Allan Rosen, Mt. Laurel, NJ (US)

Correspondence Address: HEWLETT-PACKARD COMPANY, Intellectual Property Administration, P.O. Box 272400, Fort Collins, CO, 80527-2400, US

(21) Appl. No.: 09/952,558

(22) Filed: Sep. 13, 2001

(51) Int. Cl. B41J 1/00; G06F 15/00

(52) U.S. Cl. 358/1.15

(57) ABSTRACT

A printing device contains a built-in device driver that is provided to one or more computers coupled to the printing device. The printing device is first coupled to a computer. The printing device notifies the computer that the printing device contains a built-in device driver that can be communicated to the computing device. The printing device communicates the device driver to the computing device in response to a request from the computing device to transmit the device driver. The printer may periodically update its built-in device driver by downloading an updated device driver from a server or other device.

### TECHNICAL FIELD

The present invention relates to printing devices and, more particularly, to methods and systems for storing a printer driver in a printing device and providing the printer driver to a computer coupled to the printing device.

### BACKGROUND

Printer technology continues to advance, resulting in commercially available printers having faster speed, increased print quality, and improved features. A wide range of printers are commercially available, ranging from relatively inexpensive “desktop” models with few features to more expensive “printing press” models that have many features and expandable options.

Many printers offer specific features that are implemented within the printer or implemented by an accessory device that is attached to the input or output of the printer. One or more of these optional accessory devices may be connected serially to perform various functions, such as binding documents, stapling documents, hole-punching documents, or depositing a document into an appropriate mailbox.

When configuring a printer to work with a particular computing system, a device driver (also referred to as a printer driver) associated with the printer is installed on the computing system. A device driver is a program that controls a device—in this situation, the device is a printer. The device driver functions as a translator between the printer and the application programs on the computing system that use the printer. Each printer has its own set of commands that are known by its device driver. However, the application programs on the computing system typically issue generic commands (such as change paper size, select a particular font, or perform a page feed operation). The device driver translates these generic commands into specific commands that are understood by the printer.

In existing systems, when configuring a printer to work with a particular computing system, the user of the computing system may be required to install a device driver from a storage media (such as a CD-ROM or a diskette) that is provided with the printer. For a novice computer user, or a user with little or no experience configuring computers and peripheral devices (such as printers), installing a device driver for a printer may be a difficult task. For a user that simply wants to connect the printer to the computing system and begin printing, requiring the installation of a device driver prior to printing is a tedious and frustrating task.

Another option that may be used by existing systems requires a user to download a device driver from an online source, such as a printer manufacturer's web page. If the printer is coupled to a new computer system that is being configured, the computer system may not yet have access to the Internet or other data communication network. Additionally, requiring a user to locate the proper web page and the correct device driver can be time-consuming and frustrating to a novice computer user.

In other systems, the computing system may have one or more device drivers pre-installed by the manufacturer. In this situation, the user is required to locate and install an appropriate device driver for the attached printer. Depending on when the device drivers were pre-installed on the computer, a device driver for the particular printer may not have been pre-installed if the printer is new. Thus, the pre-installed device drivers may not be appropriate for the printer attached to the computer.

The invention described herein addresses these problems by providing a printing device having a built-in device driver that can be communicated to a computer system coupled to the printer, thereby simplifying the configuration of the printer and the computer system.

### SUMMARY

A printing device contains a built-in device driver that can be provided to a computing device coupled to the printing device. By automatically communicating the built-in device driver to the computing device, a user of the computing device is not required to locate, install, or configure a device driver before using the printing device.

In a particular embodiment, a printing device notifies a computing device that the printing device contains a built-in device driver that can be communicated to the computing device. The printing device then communicates the device driver to the computing device.

In another embodiment, the printing device communicates the device driver to the computing device in response to a request from the computing device to transmit the device driver.

In one embodiment, the printing device periodically updates the device driver contained in the printer.

In another embodiment, a printer includes an input device configured to receive data from a computing device coupled to the printer. A print engine is coupled to the input device and is configured to communicate with the computing device. The print engine includes a processor and a storage device, such that the storage device contains a printer driver. An output device is coupled to the print engine. The print engine is further configured to communicate the printer driver to the computing device using the output device.

In a particular embodiment, the storage device that contains the printer driver is a programmable read-only memory device.

### BRIEF DESCRIPTION OF THE DRAWINGS

The present invention is illustrated by way of example and not limitation in the figures of the accompanying drawings. The same numbers are used throughout the figures to reference like components and/or features.

FIG. 1 is a block diagram showing pertinent components of an exemplary printer.

FIG. 2 illustrates an example printer coupled to communicate with a computer system.

FIG. 3 is a flow diagram illustrating a procedure for providing a computer with a printer driver.

FIG. 4 illustrates a network environment in which the methods and systems described herein may be implemented.

FIG. 5 is a flow diagram illustrating a procedure for updating a printer driver and communicating the printer driver to a computer.

### DETAILED DESCRIPTION

The present invention provides a printer driver contained in a printing device that can be communicated to a computing device coupled to the printing device. Once the printing device is coupled to the computing device, the printing device notifies the computing device that it has a built-in printer driver and offers to provide the printer driver to the computing device. If the computing device receives and installs the printer driver, the computing device can communicate with the printing device and send print jobs to the printing device for processing. The process of notifying the computing system of the built-in printer driver and providing the printer driver to the computing device is performed automatically without requiring any user intervention. Further, the process may be transparent to the user of the printing device and the computing device. Merely coupling the printing device to the computing device can initiate the above process, thereby simplifying the process of configuring a printing device to communicate with a computing device.

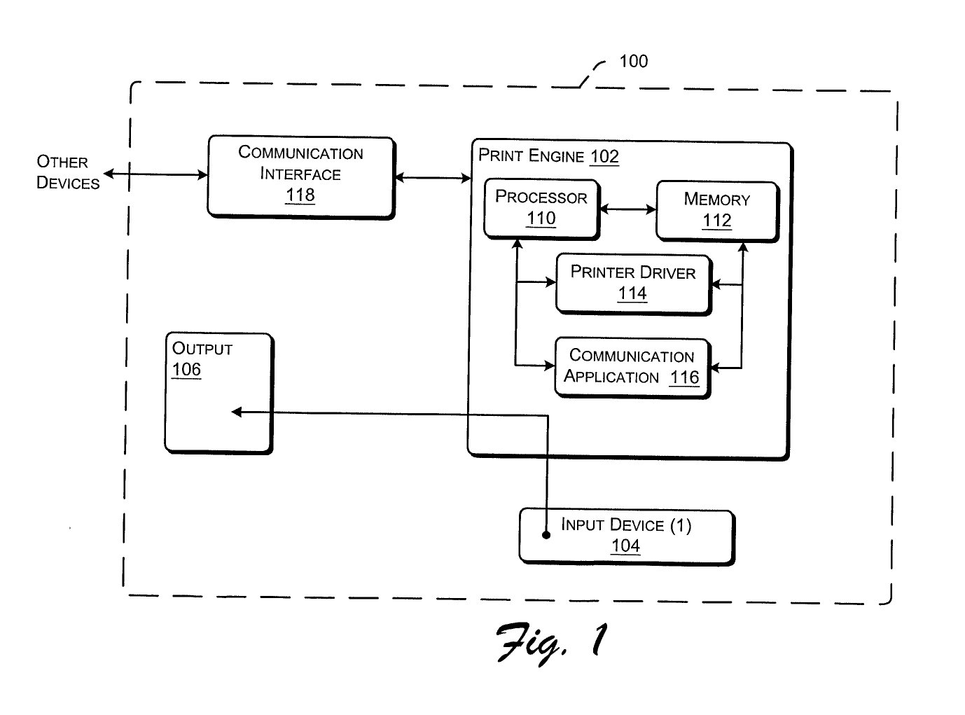

FIG. 1 is a block diagram showing pertinent components of an exemplary printer 100. As used herein, a printer refers to any type of device that can generate an image (e.g., a letter, a picture, a drawing, etc.) on any type of print media, such as paper, cardstock, plastic, or fabric. Example devices include impact printers, non-impact printers, digital copiers, analog copiers, facsimile machines, press machines, silk screen machines, etc. Printers can produce images in any of a wide variety of conventional print media (paper, plastic, fabric, etc.). However, for ease of discussion, printers are discussed herein in the context of printing on paper. A printer may also be referred to herein as a “printing device”.

Printer 100 includes a print engine 102 and an input device 104. The printer 100 also has at least one output device 106. During a printing operation, a sheet of paper is provided to print engine 102 from input device 104 or from a direct paper feed (e.g., an external direct-feed tray). As the sheet of paper passes through the print engine 102, the appropriate information is printed on the paper. The paper can be printed in any of a wide variety of conventional manners, such as a conventional laser printing process or a conventional inkjet printing process. After printing, the sheet of paper is output directly by print engine 102 to output 106, such as an output bin (or output tray), or other device capable of outputting the sheet of paper from the printer. Output 106 may be coupled to another device (not shown) that further processes the sheet of paper.

Input device 104 represents a variety of print medium sources and preprocessing devices. Example input devices include: a device with one or more paper trays for supplying one or more sizes or types of paper to print engine 102; a pre-processing device to put a “stamp” on each sheet of paper prior to printing (such as physically adding a stamp to the sheet of paper or adding a graphical image or text to the information for each page); a paper separating device that separates fan-folded media into separate sheets or to cut a sheet of paper from a roll of paper; a device to affix another piece of paper to the sheet for printing (e.g., a Post-It® Note); a hole punching device to punch hole(s) in each sheet of paper; or a scanning device, such as to obtain a serial number or other identifier from a sheet of paper to verify that pre-printed media is oriented correctly for printing.

Print engine 102, input device 104, and output device 106 can communicate with one another, transferring control information and data as necessary. Such communication may occur directly between two devices, or may be routed through print engine 102. Printer 100 includes additional components, such as a print head or other mechanism for producing the data to be printed on the sheet of paper in print engine 102.

Print engine 102 includes a processor 110 and a memory/storage device 112. Processor 110 controls the transfer of paper through printer 100, including communication of information to the input device 104 and the output device 106. Processor 110 may also communicate information to other devices coupled to printer 100. Processor 110 may be any type of microprocessor or microcontroller capable of performing the operations necessary to control the operation of printer 100. Alternatively, processor 110 may be replaced by an ASIC (application specific integrated circuit) or other customized device capable of controlling the printer 100.

Memory 112 is a volatile and/or nonvolatile memory, such as a RAM (random access memory), a ROM (read only memory), a Flash EEPROM (electronically erasable programmable read only memory), or a magnetic or optical storage device. Memory 112 stores various information generated and/or used during the operation of the printer 100. Although memory 112 is illustrated as being separate from processor 112, all or part of memory 112 may be incorporated into processor 112.

Print engine 102 also contains a printer driver 114, which provides the basic functionality required for a computer to properly process print jobs for the printer. Printer driver 114 may be stored in memory 112 or another nonvolatile storage device. In one embodiment, printer driver 114 is stored in a Flash EEPROM, which allows the printer driver to be updated periodically. In another embodiment, printer driver 114 is stored on a hard disk drive contained within the printer 100.

Print engine 102 also includes a communication application 116, which may be stored in memory 112 or another storage device. Communication application 116 is executed by processor 112 or another processor (not shown) in printer 100. Communication application 116 allows printer 100 to communicate with other devices, such as other printers, computing devices, web servers, and the like. Printer 100 may be coupled to a network, thereby allowing other devices on the network to communicate with printer 100 via communication application 116.

In an alternate embodiment, printer driver 114 and/or communication application 116 are not located in print engine 102. For example, printer driver 114 and/or communication application 116 may be part of a separate module in the printer that includes a processor and a memory or other storage device. Additional details regarding printer driver 114 and communication application 116 are provided below.

A communication interface 118 is coupled to the print engine 102 and allows the print engine to communicate with other devices, such as other printers, computers or other media processing devices (e.g., staplers, binders, or sorters) coupled to the printer 100. In a particular embodiment, communication interface 118 includes a network interface that permits communication between print engine 102 and other devices coupled to a common network. In other embodiments, communication interface may communicate via a parallel connection, a serial connection, a universal serial bus (USB) connection, or a wireless (e.g., infrared or radio frequency) connection. Although the communication interface 118 is illustrated in FIG. 1 as a separate component, in alternate embodiments, the communication interface 118 is integrated into the print engine 102. A particular printer may include any number of communication interfaces using any type of communication medium and any communication protocol.

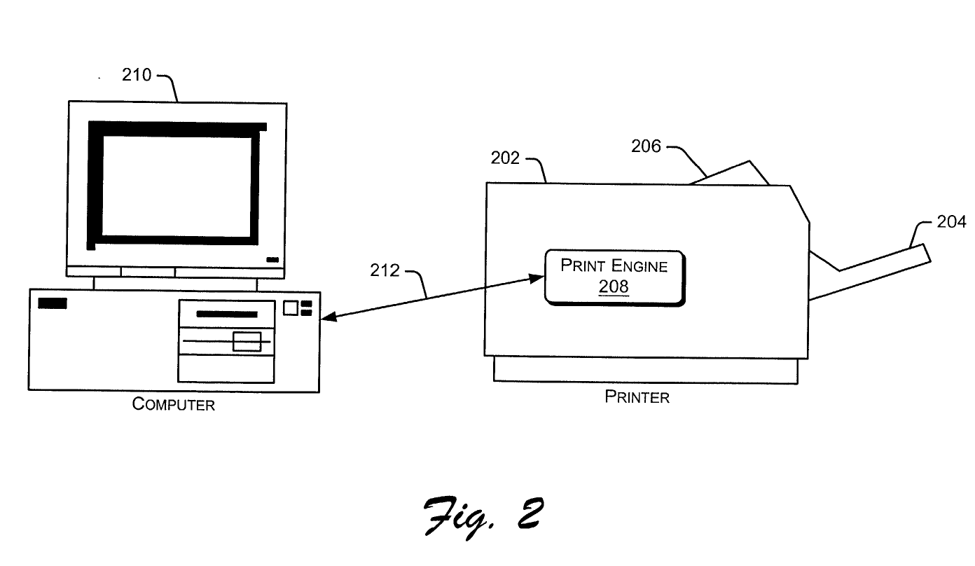

FIG. 2 illustrates an example printer 202 coupled to communicate with a computer system 210. Printer 202 includes an input tray 204, an output bin 206, and a print engine 208. Print engine 208 is similar to print engine 102 discussed above with respect to FIG. 1. Additionally, other input devices (not shown) and/or output devices may be coupled to or attached to printer 202. Print engine 208 communicates with computer system 210 via a communication link 212. Communication link 212 may be a wired or wireless link using any type of communication medium and using any communication protocol.

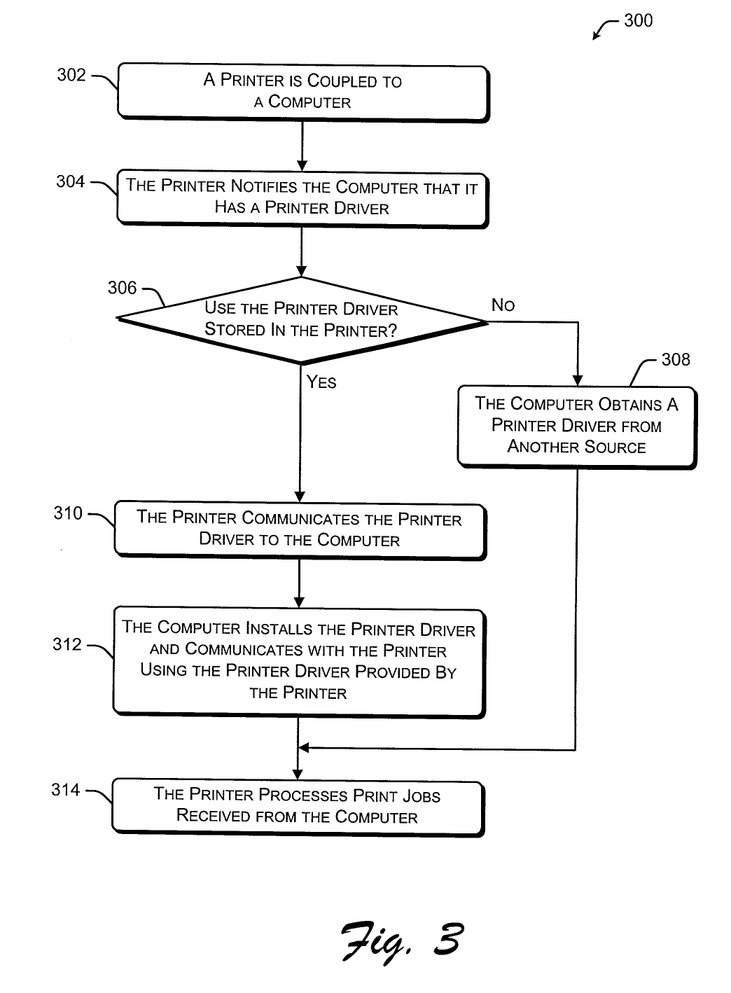

FIG. 3 is a flow diagram illustrating a procedure 300 for providing a computer with a printer driver. Initially, a printer is coupled to a computer (block 302). The printer can be coupled to the computer using, for example, a parallel communication cable or a USB communication cable. Once powered-on, the printer notifies the computer that it has a built-in printer driver (block 304). Next, the computer determines whether to use the printer driver stored in the printer (block 306). If the computer decides not to use the printer driver stored in the printer, the computer obtains an appropriate printer driver from another source (block 308).

If the computer decides to use the printer driver stored in the printer, the printer communicates the printer driver to the computer (block 310). The computer then installs the printer driver and is able to communicate with the printer using the printer driver provided by the printer (block 312). The printer then processes print jobs received from the computer (block 314).

In an alternate embodiment, the printer automatically communicates the printer driver to the computer. The computer may later update the printer driver. This embodiment ensures that the printer is operable shortly after it is coupled to the computer without requiring any user actions to identify, select, or install a printer driver in the computer.

The printer driver stored in the printer may be a complete printer driver or may contain a reduced set of functions, such as a basic set of printing functions. A reduced set of functions simplifies the printer driver and reduces the storage space required to store the printer driver in the printer. The basic set of printing functions allow the printer to print basic print jobs until a complete printer driver is installed in the computer.

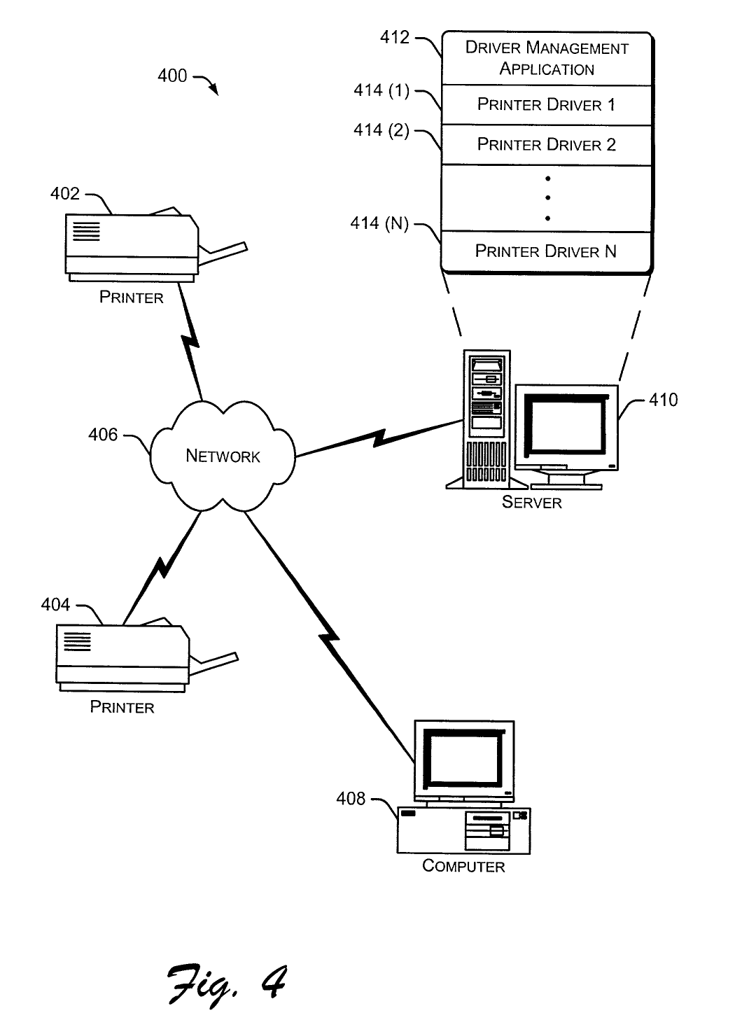

FIG. 4 illustrates a network environment 400 in which the methods and systems described herein may be implemented. Printers 402 and 404 are coupled to a network 406, thereby allowing the printers to communicate with other devices coupled to the network. Network 406 can be any type of data communication network, such as a Local Area Network (LAN), a Wide Area Network (WAN), or the Internet. In this example, printers 402 and 404 contain a built-in printer driver as described herein.

A computer 408 and a server 410 are coupled to network 406. Computer 408 is capable of sending print jobs across network 406 to printer 402 and/or printer 404. A printer driver installed in computer 408 allows applications executing on computer 408 to print to printers 402 and 404. Server 410 includes a driver management application 412 that organizes and manages various printer drivers 414 used by computers to communicate with various types and models of printers. Printer drivers 414 may be downloaded by printer 402 or 404, or may be downloaded by a computer, such as computer 408. Printers 402 and 404 may periodically download updated printer drivers 414 from server 410 and replace the printer driver stored in the printer with the downloaded printer driver.

Although FIG. 4 illustrates two printers 402 and 404, one computer 408, and one server 410, a particular environment 400 may include any number of printers, any number of computers, and any number of servers coupled together via any number of networks having any topology and using any communication protocol.

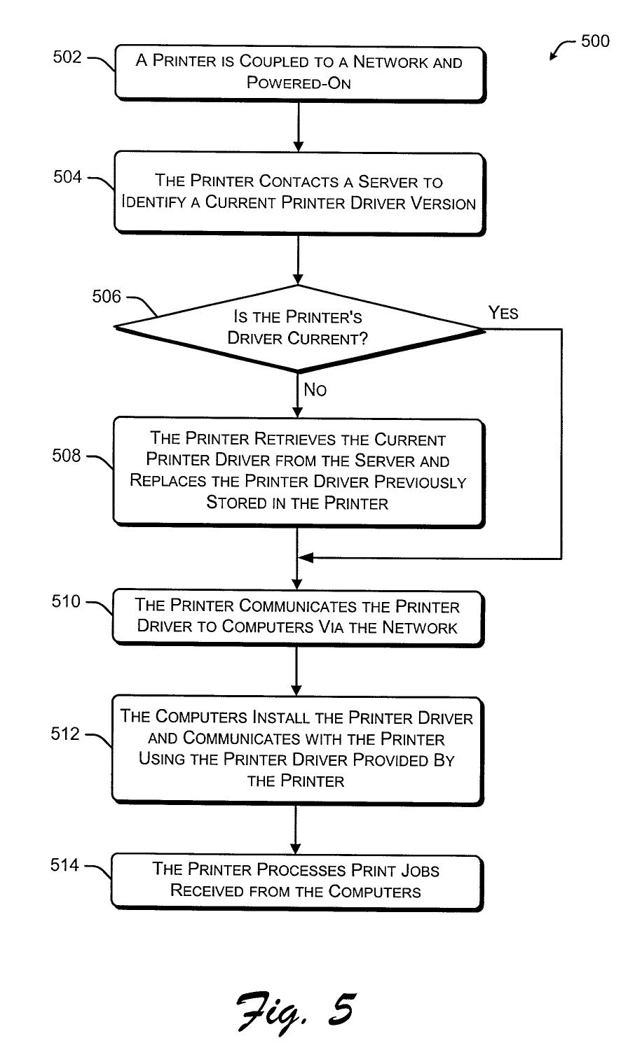

FIG. 5 is a flow diagram illustrating a procedure 500 for updating a printer driver and communicating the printer driver to a computer. Initially, a printer is coupled to a network and powered-on (block 502). The printer contacts a server coupled to the network to identify a current printer driver version associated with the printer (block 504). The printer then determines whether the printer driver stored in the printer is current (block 506). If the printer driver stored in the printer is not current, the printer retrieves the current printer driver from the server and replaces the printer driver previously stored in the printer (block 508).

The printer then communicates the printer driver to one or more computers via a data communication network (block 510). The computers install the received printer driver and communicate with the printer using the printer driver provided by the printer (block 512). The printer then processes print jobs received from the computers (block 514).

In a particular implementation, the printer also communicates the printer driver stored in the printer to each new computer that is coupled to the network and requests to receive the printer driver associated with the printer. This allows newly connected computers to begin printing to one or more printers via the network without having to install or configure any printer drivers. Also, since the printer maintains a current version of its own driver, the computer receives a current version of the printer driver directly from the printer.

In a particular embodiment, the print engine in a printer also contains a help file (i.e., help instructions for the user of the printer) that assists the user of the printer and/or the computer coupled to the printer to install printer drivers, update printer drivers, execute various printer functions, or perform other operations. Additionally, the help file may provide a uniform resource locator (URL) that identifies a web page that contains an updated printer driver for the printer. The information contained in the help file may be displayed on the computer and/or a display device on the printer. Alternatively, the information contained in the help file may be printed by the printer for use by the operator of the printer and/or computer. This help file may be stored in the computer or in a memory device (such as memory 112) in the printer. The help file may be updated in a manner similar to the procedure for updating printer drivers discussed above.

Thus, systems and methods for providing a printer driver stored in a printer to one or more computers are described herein. The described embodiments simplify the configuration of a printer and a computer system by automatically installing the appropriate printer driver on a computer coupled to the printer.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
a printing device notifying a computing device that the printing device contains a built-in device driver that can be communicated to the computing device; and
the printing device communicating the device driver to the computing device.

2. A method as recited in claim 1 further comprising coupling the printing device to the computing device prior to the printing device notifying the computing device.

3. A method as recited in claim 1 wherein the printing device communicates the device driver to the computing device in response to a request from the computing device to transmit the device driver.

4. A method as recited in claim 1 further comprising the computing device installing the device driver.

5. A method as recited in claim 1 further comprising:
the computing device installing the device driver; and
the computing device communicating with the printing device using the device driver.

6. A method as recited in claim 1 further comprising the computing device communicating print jobs to the printing device using information contained in the device driver.

7. A method as recited in claim 1 further comprising the printing device periodically updating the device driver contained in the printer.

8. A method as recited in claim 1 further comprising the printing device displaying a help file to a user of the printing device.

9. A method as recited in claim 1 wherein the printing device is coupled to a network, the method further comprising the printing device communicating the device driver to each new computer that is coupled to the network.

10. A method comprising:
coupling a printer to a first computing device, wherein the first computing device stores a current version of a printer driver associated with the printer;
determining whether the current version of the printer driver associated with the printer is more current than a printer driver contained in the printer;
if the current version of the printer driver associated with the printer is more current than the printer driver contained in the printer, then:
the printer retrieving the current version of the printer driver from the first computing device and replacing the previous printer driver contained in the printer with the current version of the printer driver; and
the printer communicating the current version of the printer driver to a second computing device coupled to the printer, wherein the second computing device communicates print jobs to the printer;
if the printer driver contained in the printer is the current version of the printer driver, then the printer communicates the printer driver to a second computing device coupled to the printer, wherein the second computing device communicates print jobs to the printer.

11. A method as recited in claim 10 further comprising the second computing device installing the printer driver received from the printer.

12. A method as recited in claim 10 further comprising:
the second computing device installing the printer driver received from the printer; and
the second computing device communicating with the printer using information contained in the printer driver received from the printer.

13. A method as recited in claim 10 wherein the first computing device stores current versions of printer drivers associated with a plurality of printers.

14. A method as recited in claim 10 wherein the printer driver contained in the printer is stored on a reprogrammable memory device.

15. A method as recited in claim 10 wherein the printer driver contained in the printer is stored on a hard disk drive in the printer.

16. A printer comprising:
an input device configured to receive data from a computing device coupled to the printer;
a print engine coupled to the input device and configured to communicate with the computing device, the print engine including a processor and a storage device, wherein the storage device contains a printer driver; and
an output device coupled to the print engine, wherein the print engine is further configured to communicate the printer driver to the computing device using the output device.

17. A printer as recited in claim 16 wherein the storage device is a non-volatile memory device.

18. A printer as recited in claim 16 wherein the storage device is a programmable read-only memory device.

19. A printer as recited in claim 16 wherein the storage device further contains a help file that assists the user in retrieving a new device driver.

20. A printer as recited in claim 16 wherein the storage device further contains a help file that identifies a location for retrieving a current device driver associated with the printer.

21. A printer as recited in claim 16 further comprising a communication application coupled to the processor and configured to communicate with a computing device to receive an updated version of the printer driver.
